(19) United States
(12) Patent Application Publication
(10) Pub. No.: US 2006/0125297 A1
(43) Pub. Date: Jun. 15, 2006

(54) Motor vehicle seat

(76) Inventor: Vasilios Orizaris, Renningen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/529,370

(22) PCT Filed: Sep. 3, 2003
(86) PCT No.: PCT/EP03/09765

§ 371 Date: Oct. 14, 2005

(30) Foreign Application Priority Data
Sep. 27, 2002 (DE) 103 45 253.9

(51) Int. Cl. B60N 2/42

(52) U.S. Cl. 297/216.12

(57) ABSTRACT

A motor vehicle seat with a seat back has a seat back support and a head support attached to the seat back support by a connection element. The motor vehicle seat increases vehicle passenger safety despite its simple construction by connecting the head support to the seat back support. In addition, the head support is positioned relative to the seat back support so that, in the event of an accident, a support of the head of the vehicle passenger occurs in a forward deployed position in relation to the upper body, so that a relative movement between the head and the upper body is prevented.

### BACKGROUND AND SUMMARY OF THE INVENTION

The invention involves a motor vehicle seat.

In the event of an abrupt vehicle deceleration, like with a frontal impact or a rear impact of a vehicle against an obstacle, the vehicle decelerates, at first, more quickly than a passenger located inside the vehicle, so that there is a relative movement between the passenger and the vehicle. In a frontal impact, the passenger moves forward in the vehicle. This forward movement of the passenger inside the vehicle follows, as a rule, a movement aimed to the rear. In an impact from the rear, there is an immediate movement to the rear. That results in the danger of cervical vertebrae injuries, especially in an end phase in which the upper body of the passenger again rests on the seat, while the head moves still further backward relative to the upper body.

A variety of so-called “active head supports” are known by means of which the danger of cervical vertebrae injuries is minimized. Active head supports are based on the fundamental idea that the head support should be displaced forward relative to the vehicle seat in the event of an impact to thereby reduce the separation between the head and the head support so that, when the vehicle passenger executes a movement to the rear, the head and the upper body move at about the same time to contact with the head rest and back of the seat. As an example, German document DE 100 58 518 A1 is mentioned. That document discloses a seat back of a motor vehicle including seat back supports with a head support. The head support is secured to the back of the seat with rod-shaped connection elements. A power element works in conjunction with the connecting elements so that, in the event of an accident, a displacement of the entire head support occurs in relation to the seat back. In an inactive operating condition of the activation elements, i.e., during normal driving operations of the vehicle, the head support assumes a lowered position toward the rear with respect to the seat back. In the activated operating condition of the activation elements, the head support assumes a slightly elevated position swung to the front. The forward moved position of the head support in the event of an accident prevents a backward displacement of the head relative to the upper body of a vehicle passenger in the end phase of a movement to the rear.

In addition, a seat back with a two-part head support is known from German document DE 197 07 998 A1. The head support manifests a fixed part and a movable part, whereby the movable part is located on the side of the head support facing the passenger. The two parts are connected to each other by a lever suspension, by means of which the movable part can be moved from a normal position to a protective position. In the event of an accident, only a part of the head support rather than the entire head support thus moves. The protective position lies somewhat higher and more forward in comparison to the normal position. As the power for the displacement of the movable part, two energy accumulators are provided. To support the movable part in the extended position, support levers are provided in addition to the levers for movement. The movable part can be moved from the protective position back to the normal position by traction cables engaging these support levers.

A comparable head support is described in German document DE 100 41 528 A1.

A disadvantage of these known active head supports is that they have relatively expensive constructions. Such an expensive construction causes high costs in manufacture as well as in assembly. In addition, activation elements must be provided, in order to attain movement of parts or the entire head support. In addition, the head support unit must be connected to a control system which guarantees an activation at the proper time. Both the activation elements as well as the control system increase the complexity and thus the costs of such a system significantly.

Motor vehicle seats with seat backs and head supports are disclosed in German document DE 199 27 403 A1 and Japanese document JP 10 119616A. Here, shaping pillows are integrated into seat backs and/or head supports with resiliencies designed especially for impacts. The resiliencies of the shaping pillows can thereby be constructed in various ways.

Against that background, this invention has the basic goal of creating a motor vehicle seat which despite its simple construction increases the safety of vehicle passengers.

This goal is attained by a motor vehicle seat as claimed.

Accordingly the invention is characterized by a motor vehicle seat with a seat back support, whereby a head support is connected to the seat back support by a connection element. According to the invention the head support is connected with the seat back support.

The head support manifests an impact plate with a basically flat area that is positioned on the side of the head support facing the vehicle passenger. A flat impact plate has the advantage of a two-dimensional contact of the head on the head support. In contrast to a point contact of the head, the two dimensional contact ensures, in the event of an accident, secure retention of the head on the head support and avoids a rolling away of the head in an uncontrolled direction with the possible consequence of injuries. The impact plate can manifest a certain strength, so that an excessive penetration of the head into the head support can be avoided during an impact. As a result the head can be braked further forward relative to the upper body, whereby the effect of the head support of the invention is reinforced. The stiffness or strength can occur by the selection of the material of the impact plate. Conceivable are common plastics such as, for example, PE, PE-HD, PP, PP-GF, ABS, PA, PSA-GF, EPP, and EPS. The impact plate can be overlaid with common covering material, so that optically it matches the interior of the vehicle.

The impact plate is positioned to swing around a horizontal axis on the head support, so that its position can be adjusted. There is thus the possibility, that each vehicle passenger can so adjust the head support as to fit his or her individual needs. If the impact plate forms only a part of the head support, the head support manifests a fixed part as well as a part that swivels relative to it, namely the impact plate. According to another embodiment, the swivel movement can be so limited that swinging is only possible within certain limits. In the process, the limits for the swivel movement can be so selected that, independent of a position of the impact plate lying within these limits during an accident, it is guaranteed, in every case, that the head of the vehicle passenger comes to rest on the head support in two-dimensions and not on a point. That has the advantages that, independent of the position of the impact plate selected, both an optimal contact of the head on the head support and the highest safety for the vehicle passengers are guaranteed.

The swivel axis of the impact plate on the head support can be so positioned that, in the event of an accident, the head of the vehicle passenger always comes to rest as close as possible to the swivel axis. As a result, the forces acting on the impact plate in the vicinity of the swivel axis are passed to the impact plate, whereupon small lever arms emerge. Because of the small lever arms, backward movement of the head is limited when the impact plate is displaced to the rear because of the redirected forces. As a result, the head is held in a position lying as far forward as possible, and an unnecessary backward displacement of the head is prevented. The effect of the invention is also thereby reinforced by preventing movement of the head to the rear, especially in relation to the upper body of the vehicle passenger.

In contrast to the technology discussed at the outset, the invention has the advantage of omitting a procedure for head support or parts of it in the event of an impact. As a result, the vehicle seat of the invention is, basically, simpler to manufacture and install. That entails significant cost advantages. In addition, no expensive control is necessary in the arrangement of the invention, which, in addition to the cost advantage, represents an advantage with regard to the reliability of the system; in order to be effective, the construction of the invention does not have to move. It is constantly effective. Thus, by means of the invention, there is a constantly ready and very reliable system available. In addition, it is also important that a non-moving system is much more simple to design with regard to its fatigue strength. During its lifetime, the head support is subject to other demands; for example, the head support frequently serves as a handle for persons sitting in the rear to pull themselves up when exiting.

The connecting element to secure the head support to the seat back support can be constructed as a curve. For example, two rod-shaped connection elements can be provided which are aligned parallel to each other and which extend between the seat back support and the head support. In order to avoid any displacement of the head support relative to the seat back in the event of an accident, the connection elements can be produced from a high strength material, for example steel. In this way the connection elements can be prevented from deforming when, in the event of an accident, the head comes in contact with the head support after its movement to the rear. Naturally other materials are conceivable, like plastics and other metals.

The connection can be so designed that it permits a translational movement of the connection elements relative to the seat back support. It is also is so aligned, relative to the support, that, in the event of an accident, it is capable of supporting the head of a vehicle passenger in a position which is positioned forward relative to the upper body of the vehicle passenger. As a result, in an impact, a movement of the vehicle passenger to the rear can be arrested, and the head, in the end phase of the movement, does not move further backward relative to the upper body. Instead, the movement of the head is stopped at about the same time as the movement of the upper body. In other words, the arrangement of the invention ensures that the backward movement of a vehicle passenger in an accident is braked so that there is no relative movement between the head and the upper body. As a result, cervical vertebrae injuries can be avoided.

The curvature of the connection elements as well as their alignment relative to the seat back can be selected so that, independent of the position of the seat back, which for comfort reasons can be adjusted in its height as well as its inclination, as well as the head support, which also can be adjusted in height for comfort reasons, the head support is also so aligned relative to the seat back support that, in the event of an accident, a support of the head is assumed in a forward displaced position relative to the upper body. In order to guarantee that, the movement paths of the seat back and head support, the radius of the connection elements, and the alignment of the connection elements to the seat back must be exactly matched to each other.

The seat back support can manifest a transverse traverse which basically consists of a U-shaped profile. The transverse traverse extends horizontally in the seat back and is placed on its upper end. It can serve, for example, to accept the connection elements.

The U-shaped profile can manifest a base and two angled, for example rectangularly aligned, side flanks. The U-shaped profile can point away from the vehicle passenger with its open side, so that the base is aimed at the vehicle passenger. If the base is longer than the two sides, there is an especially positive arrangement with respect to passenger safety. The relatively short sides result in the protrusion of the transverse traverse into the seat back being minimized in the vehicle longitudinal direction so that, during a rearward movement of the upper body of the vehicle passenger, he or she can immerse into the seat back relatively far. This arrangement again supports the underlying principle of the invention of holding the head in a forward position relative to the upper body of the vehicle passenger.

The transverse traverse can manifest receptacles for the connection element. The receptacles can be emplaced in the side flanks of the U-profile and may consist, for example, of drilled holes in the side flanks. In this case, the connection elements will completely penetrate the transverse traverse. The longer the base of the U-shaped profile, the further the receptacle holes are from each other in the side flanks, and the better the support of the head support is, for it will then form a longer lever. In addition, the strength of the connection can be supported by a casing which permits a translation movement of the connection elements but prevents a tipping movement.

The areas of the transverse traverse facing the sides of the seat back can be constructed with a slight incline in the direction of the vehicle passenger. As a result, the vehicle passenger experiences a slight support in the area of the shoulders which acts positively on a sense of comfort. All in all, the contact of the upper body on the seat back should be two-dimensional.

It is also conceivable to have the areas of the transverse traverse facing the sides of the seat back be movable. The areas, for example, may be connected with the other transverse traverse so as to swivel. During an accident, a further immersion of the vehicle passenger into the seat back would then be possible, since the side area of the transverse traverse swivels to the rear.

Padding is provided on the side of the seat back facing the passenger. The strain hardening of the padding can be so selected that two conditions are met. First, the padding sufficiently holds the passenger during normal operation, so that comfortable sitting is possible. Second, in the event of an accident, the padding permits an immersion of the upper body of the passenger into the seat back. In this manner, more room is made available for the backward movement of the upper body.

The invention is explained below in more detail using drawings.

### BRIEF DESCRIPTION OF THE DRAWINGS

FIG. 1 is a vertical longitudinal section through a seat back of a motor vehicle seat of the invention.

FIG. 2 is a horizontal transverse section through a seat back of a motor vehicle seat of the invention at the elevation of a transverse traverse.

FIG. 3 is a side view of a seat back of a motor vehicle seat of the invention.

### DETAILED DESCRIPTION OF THE INVENTION

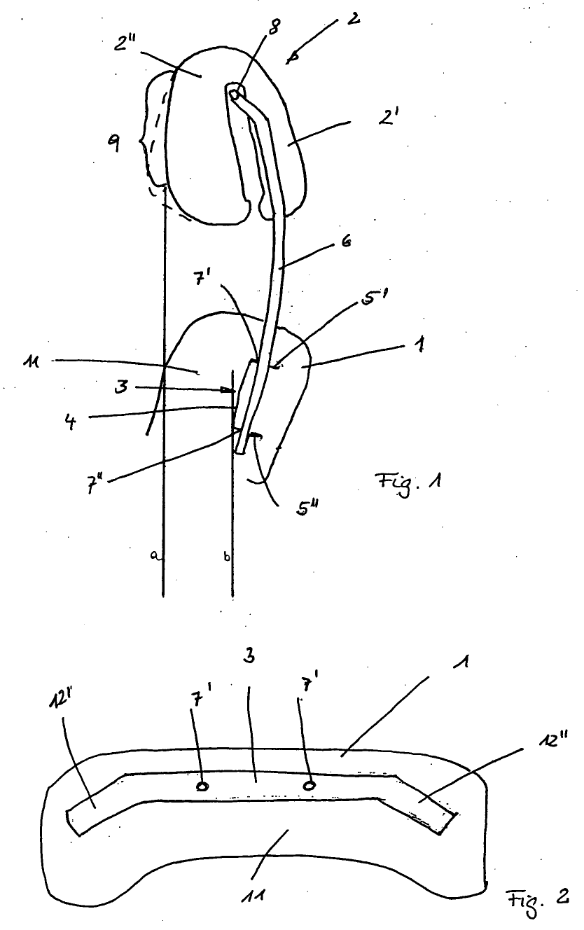

In FIG. 1 a vertical longitudinal cut through a seat back 1 of a motor vehicle seat of the invention with a head support 2 is depicted. The seat back 1 manifests a seat back support from which U-shaped a transverse traverse is shown in FIG. 1. The transverse traverse 3 consists of a U-shaped profile which manifests a base 4 as well as two side flanks 5′ and 5″. The base 4 is longer than the two side flanks 5′ and 5″. The U-shaped transverse traverse 3 is aligned in the seat back so that it has the base 4 facing in the direction of a vehicle passenger sitting on the seat. Its opened side thus points to an area lying behind the vehicle seat.

The head support 2 is connected to the seat back 1 by means of a long connection element 6. The connection element 6 is constructed in a rod-shape. The downward-pointing end of the connection element 6 is connected to the transverse traverse 3 of the seat back support. For that reason holes 7 and 7″ are provided in the side flanks 5′ and 5″ of the transverse traverse 3. The head support 2 is positioned on the upward-pointing end of the connection element 6. The head support is constructed in two parts. It manifests a fixed back part 2′, as well as a part 2″ pointing forward in the direction of the vehicle passenger. The part 2″ pointing forward is connected with the rear part 2′ so as to swivel on a horizontal axis 8.

The seat back 1 and the head support 2 are characterized by the following properties, each of which contributes to the head and upper body of the vehicle passenger in the event of an accident making contact because of the rearward movement of the passenger due to the accident at about the same time on the seat back 1 and the head rest 2, so that there is no relative movement between the head and upper body. The head support 2 is positioned so far forward in relation to the seat back support, especially the transverse traverse 3, that independent of which position the seat back 1 and/or head support 2 assume/assumes, the area of the head support 2 pointing forward is always positioned in front of the transverse traverse 3. In FIG. 1 the distance between the head support 2 and the transverse traverse 3 is shown by the vertical parallel auxiliary lines a and b. The forward-pointing part 2′ of the head support 2 manifests an area 9 with a basically flat surface, a type of impact plate 9. This impact plate 9 guarantees a two-dimensional contact for the head independent of the possible contact location on the head support 2, whereby an uncontrolled rolling away of the head is prevented and retention in a safe position is aided. The edge area of the head support 2 is constructed in a rounded manner, in order to prevent an injury in the event of an impact on this area.

The swivel movement of the front part 2″ of the head support is limited. In FIG. 1 the two extreme positions are depicted. The solid line shows the rearmost and the dashed line the forward position. By means of a limitation of the swivel movement the act of the head always coming in contact on the two-dimensional impact plate 9 in the event of an impact is aided. As an example, a swivel range of 15 degrees between the two extreme positions is named.

If, in addition, the impact plate 9 is so dimensioned and designed that the first contact location of the head in an accident lies as much as possible in the vicinity of the swivel axis 8, then the backward movement of the head is minimized because of a backward displacement of the swiveling impact plate 9, since either a small or no lever action is present.

The connection element 6 is constructed in a curved manner. Its curve points in the direction of the vehicle passenger. The radius of the curve is selected to be relatively large, for example 850 mm. The radius of the connection element 6 and the arrangement of the connection element 6 on the seat back 1 is so selected that, independent of the position of the seat back 1—namely—regardless of how much it is inclined to the front or rear or at what height it is set, the head support 2 is also so positioned, relative to the seat back support 3, that in the event of an impact it catches the head at about the same time as the seat back 1 catches the upper body. That means, in other words, that the head support 2 is always positioned in front of the seat back support 3; thus between auxiliary lines a and b there is always a separation. The radius can even be so selected that the further the seat back 1 is inclined to the rear, the further forward the head support 2 moves relative to the seat back support 3. That has the advantage that, for large persons who naturally adjust the seat back 1 relatively far to the rear and who also naturally experience a greater acceleration in an accident, the head is caught further forward.

The seat back 1 is provided with padding 11 on its front side. The padding 11 is constructed relatively thick, so that in the case of an accident, a deep immersion of the upper body into the padding is possible. For that reason the padding 11 also manifests material properties which facilitate such a penetration. Energy can thereby be absorbed by a deformation of the upholstery 11. The material of the padding 11 is selected so that it ensures sufficient seating comfort during normal driving.

As previously stated, the transverse traverse 3 is so constructed that the base 4 is longer than the side flanks 5′ and 5″. That entails two advantages. First, the penetration path for the upper body is larger in comparison to a profile with longer side flanks. Second, because of the relatively large distance between the holes 7′ and 7″ a stable position is made available for the connection element 6, so that a secure support for the head support 2 is guaranteed. It can be advantageous if a guide bushing without any play is provided in the holes 7′ and 7″.

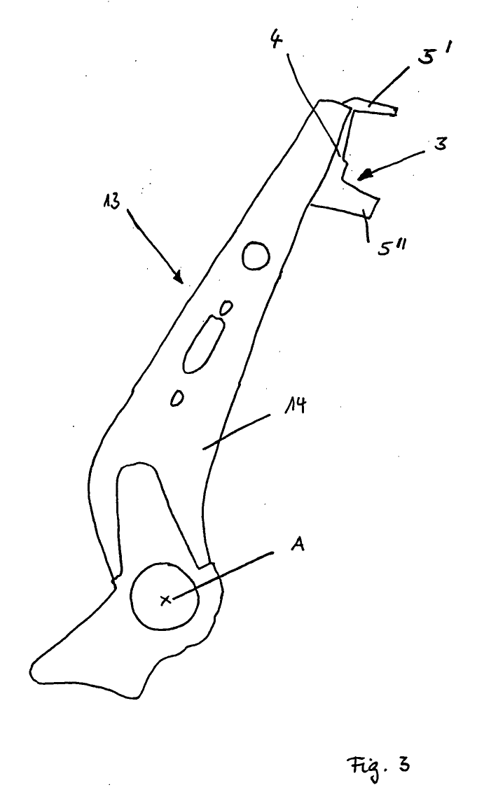

In FIG. 2 a horizontal cross-section of the seat back 1 is shown at the elevation of the transverse traverse 3. Two holes 7′ can be recognized in the transverse traverse 3. The head support 2 is attached, in the embodiment shown, to the transverse traverse 3 by means of two identical connection elements 6 positioned next to each other. It can also be seen that the areas 12′ and 12″ of the transverse traverse 3 facing the sides of the seat back 1 are inclined to the front. This arrangement increases the seat comfort, because the contour of the seat back is fitted to that of the upper body. The inclination is so selected that a basically two-dimensional contact of the upper body to the seat back 1 is guaranteed. In order to be certain that a sufficient path for the backward displacement of the upper body is available, the areas 12′ and 12″ are connected to the transverse traverse 3 so as to move and in the event of an accident and an impact of the upper body move backward to the seat back.

In FIG. 3, a seat back support 13 is shown in a side view. The seat back support 13 manifests two parallel running seat back side portions of which only one seat back side part 14 can be seen in FIG. 3. The seat side part 14 is positioned so as to swivel around a turning axis A. The side part 14 is slightly bent in its upper area in the direction of travel. Also visible in the upper area is the U-shaped transverse traverse 3 with its base 4, as well as both side flanks 5′ and 5″ by means of which the two seat side parts are connected to each other in a U-shaped configuration standing on the head.

1-9. (canceled)

10. A motor vehicle seat comprising
a seat back with a seat back support, and
a head support attached to the seat back support by a connection element,
wherein the head support defines an impact plate on a side facing a vehicle passenger with a basically flat area,
wherein the impact plate is positioned so as to swivel around a horizontal swivel axis, and
wherein the swivel axis of the impact plate is positioned in the vicinity of a contact location of a head of the vehicle passenger on the head support.

11. The motor vehicle seat according to claim 10, wherein swivel movement of the impact plate is limited so that, independent of the position of the impact plate, two-dimensional contact of the head on the head support is guaranteed in the event of an accident.

12. The motor vehicle seat according to claim 10, wherein the connection element is curved.

13. The motor vehicle seat according to claim 12, wherein a radius of the connection element and alignment of the connection element relative to the seat back support is selected so that, independent of the position of the seat back as well as the head support, the head support provides a support of the head in a forward deployed position in relation to the upper body.

14. The motor vehicle seat according to claim 10, wherein the seat back support has a transverse traverse with a U-shaped profile.

15. The motor vehicle seat according to claim 14, wherein the U-shaped profile has a base and two side flanks, and wherein the base is longer than the side flanks.

16. The motor vehicle seat according to claim 15, wherein the transverse traverse has at least one receptacle for the connection element.

17. The motor vehicle seat according to claim 16, wherein the receptacle is made in the side flanks.

18. The motor vehicle seat according to claim 14, wherein areas of the transverse traverse facing sides of the seat back are inclined to the front.
